(19) United States
(12) Patent Application Publication
(10) Pub. No.: US 2024/0201703 A1
(43) Pub. Date: Jun. 20, 2024

(54) METHOD AND APPARATUS FOR PLANNING MISSION FORWARDING PATH FOR A MEGA-CONSTELLATION, AND NON-TRANSITORY STORAGE MEDIUM

(71) Applicants: Nanjing University of Aeronautics and Astronautics, Nanjing (CN); Harbin Institute of Technology, Harbin (CN)

(72) Inventors: Yunhua WU, Nanjing (CN); Yuhe MAO, Nanjing (CN); Xibin CAO, Harbin (CN); Shi QIU, Harbin (CN); Xueqin CHEN, Harbin (CN); Ning LI, Harbin (CN)

(73) Assignees: Nanjing University of Aeronautics and Astronautics, Nanjing (CN); Harbin Institute of Technology, Harbin (CN)

(21) Appl. No.: 18/522,718

(22) Filed: Nov. 29, 2023

(30) Foreign Application Priority Data
Dec. 16, 2022 (CN) 202211627362.4

(51) Int. Cl. G05D 1/646; G05D 1/644

(52) U.S. Cl. CPC G05D 1/646; G05D 1/644

(57) ABSTRACT

Disclosed are a method, an apparatus and a non-transitory storage medium. The method includes: dividing satellites of the mega-constellation into satellite topology groups, so as to construct corresponding space-time grids, obtaining a dynamic matching relationship in time domain between the space-time grids and the satellite topology groups, setting a path weight for each space-time grid, acquiring a static grid path for forwarding a mission, where the static grid path is determined by an order of the space-time grids that need to be passed sequentially to forward the mission, adjusting the static grid path according to the satellite node currently receiving the mission and the dynamic matching relationship, so as to acquire the next satellite node to which the mission is forwarded from the satellite node currently receiving the mission.

### CROSS-REFERENCE TO RELATED APPLICATIONS

The present disclosure is based on and claims the priority to Chinese Patent Application No. 202211627362.4, filed on Dec. 16, 2022, the disclosure of which is hereby incorporated by reference in its entirety.

### BACKGROUND

A low-orbit mega-constellation has the advantages of wide coverage area, large number of satellites, and low communication latency. By establishing a satellite interconnection system and deploying ground gateway stations, it can provide broader application prospects for global interconnected communications.

Traditional constellation mission planning solutions usually require ground stations to conduct operation management and issue instructions to the satellites executing the mission, which makes it difficult to ensure high real-time requirements when facing global multi-users and sudden missions. At the same time, a low-orbit mega-constellation has the characteristics of large number of satellites and short transit time. These characteristics make it difficult for limited ground station resources to achieve long-term orbital dynamics evolution and planning missions for large-scale satellites in a short time. In order to realize autonomous mission planning of the constellation, it is necessary to establish a precise management framework for the constellation to efficiently allocate satellite resources.

### SUMMARY

The present disclosure relates to the technical field of management and mission planning of a mega-constellation, and in particular, to a method and an apparatus for planning mission forwarding path for a mega-constellation, and a non-transitory storage medium.

The present disclosure provides a method and an apparatus for planning mission forwarding path for a mega-constellation, and a non-transitory storage medium, which can simplify the on-board mission planning process, reduce system delays, and provide solutions for efficient transmission of inter-satellite information, autonomous operation and mission planning of the low-orbit mega-constellation.

According to a first aspect of the present disclosure, a method for planning mission forwarding path for a mega-constellation is provided. The method includes:
dividing satellites of the mega-constellation into satellite topology groups, so as to construct corresponding space-time grids based on a coverage on ground of each satellite topology group,
obtaining a dynamic matching relationship in time domain between the space-time grids and the satellite topology groups based on a trajectory path of a sub-satellite point of satellites in each satellite topology group,
setting a path weight for each space-time grid according to constellation deployment characteristic relationships and demand indicators,
acquiring a static grid path for forwarding a mission by searching in the space-time grids based on a shortest path algorithm according to the path weight, where the static grid path is determined by an order of the space-time grids that need to be passed sequentially to forward the mission,
adjusting the static grid path according to the satellite node currently receiving the mission and the dynamic matching relationship, so as to acquire the next satellite node to which the mission is forwarded from the satellite node currently receiving the mission.

According to a second aspect of the present disclosure, an apparatus for planning mission forwarding path for a mega-constellation is provided. The apparatus includes:
a memory and a processor, where
the memory is configured for storing computer-readable instructions capable of running on the processor, and
the processor is configured for performing the following steps by running the computer-readable instructions:
dividing satellites of the mega-constellation into satellite topology groups, so as to construct corresponding space-time grids based on a coverage on ground of each satellite topology group,
obtaining a dynamic matching relationship in time domain between the space-time grids and the satellite topology groups based on a trajectory path of a sub-satellite point of satellites in each satellite topology group,
setting a path weight for each space-time grid according to constellation deployment characteristic relationships and demand indicators,
acquiring a static grid path for forwarding a mission by searching in the space-time grids based on a shortest path algorithm according to the path weight, where the static grid path is determined by an order of the space-time grids that need to be passed sequentially to forward the mission,
adjusting the static grid path according to the satellite node currently receiving the mission and the dynamic matching relationship, so as to acquire the next satellite node to which the mission is forwarded from the satellite node currently receiving the mission.

According to a third aspect of the present disclosure, a non-transitory storage medium is provided. The non-transitory storage medium has stored thereon computer-readable instructions that, when executed by a processor, cause the processor to perform the method for planning mission forwarding path for a mega-constellation as described in the first aspect.

The disclosure provides a method and an apparatus for planning mission forwarding path for a mega-constellation, and a non-transitory storage medium. By using space-time grid technology, the highly dynamic and complex constellation dynamic evolution model is transformed into a discrete grid matching of constellation resources and time and space angles to achieve routing for mega-constellation long-distance mission planning, thereby transforming complex long-term orbit evolution and dynamic planning problems into resource decisions within a discrete space-time grid, thus simplifying the on-board mission planning process and reducing system latency, providing solutions for efficient inter-satellite information transmission, autonomous operation and mission planning of the low-orbit mega-constellation.

### BRIEF DESCRIPTION OF THE DRAWINGS

FIG. 1 is a schematic diagram of a mega-constellation suitable for embodiments of the present disclosure.

FIG. 2 is a schematic flowchart of a method for planning mission forwarding path for a mega-constellation provided by the present disclosure.

FIG. 3 is a schematic diagram of the first-level grid division provided by the present disclosure.

FIG. 4 is a schematic diagram of satellite path translation recursion provided by the present disclosure.

FIG. 5 is a schematic diagram of the static grid path provided by the present disclosure.

FIG. 6 is a schematic flow chart of dynamic adjustment provided by the present disclosure.

FIG. 7 is a schematic diagram of an apparatus for planning mission forwarding path for a mega-constellation provided by the present disclosure.

### DETAILED DESCRIPTION OF THE EMBODIMENTS

In the following, the present disclosure will be described clearly and completely by way of exemplary embodiments in conjunction with the accompanying drawings.

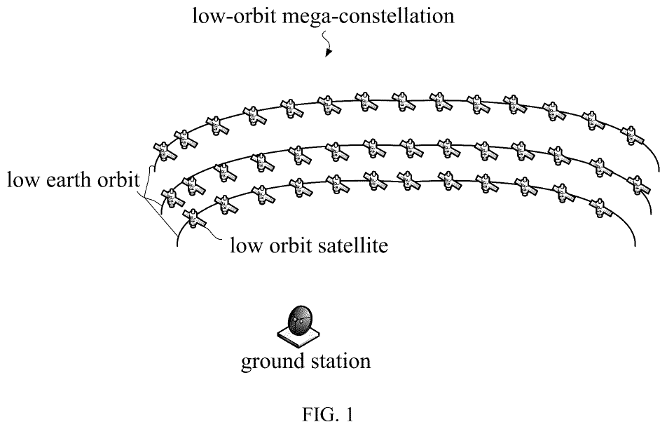

Referring to the schematic diagram of a low-orbit mega-constellation that can be applied to the technical solution of the present disclosure shown in FIG. 1, due to the large number of satellites in the low-orbit mega-constellation and the short transit time, it is difficult to achieve the dynamic evolution process of the orbits of large-scale satellites in a short time with limited ground station resources. Based on this, the present disclosure hopes to transform the highly dynamic and complex constellation dynamic evolution model into a discrete grid matching of constellation resources and time and space angles by using space-time grid technology, thereby transforming complex long-term orbit evolution and dynamic planning problems into resource decisions within a discrete space-time grid, thus simplifying the on-board mission planning process and reducing system latency, providing solutions for efficient inter-satellite information transmission, autonomous operation and mission planning of the low-orbit mega-constellation.

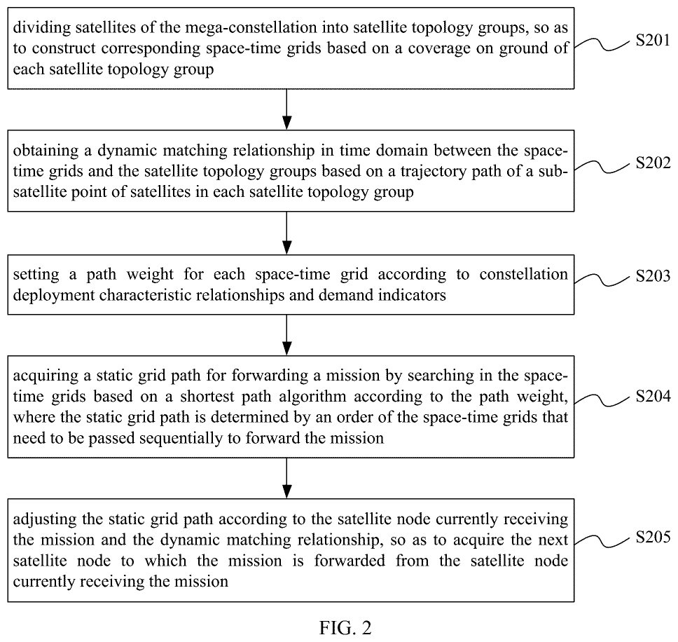

In view of the above, please refer to FIG. 2, which shows method for planning mission forwarding path for a mega-constellation provided by the present disclosure. The method may include steps S201 to S205.
S201: dividing satellites of the mega-constellation into satellite topology groups, so as to construct corresponding space-time grids based on a coverage on ground of each satellite topology group,
S202: obtaining a dynamic matching relationship in time domain between the space-time grids and the satellite topology groups based on a trajectory path of a sub-satellite point of satellites in each satellite topology group,
S203: setting a path weight for each space-time grid according to constellation deployment characteristic relationships and demand indicators,
S204: acquiring a static grid path for forwarding a mission by searching in the space-time grids based on a shortest path algorithm according to the path weight, where the static grid path is determined by an order of the space-time grids that need to be passed sequentially to forward the mission,
S205: adjusting the static grid path according to the satellite node currently receiving the mission and the dynamic matching relationship, so as to acquire the next satellite node to which the mission is forwarded from the satellite node currently receiving the mission.

Through the technical solution shown in FIG. 2, space-time grid technology is used to transform the highly dynamic and complex constellation dynamic evolution model into a discrete grid matching of constellation resources and time and space angles to achieve routing for mega-constellation long-distance mission planning, thereby transforming complex long-term orbit evolution and dynamic planning problems into resource decisions within a discrete space-time grid, thus simplifying the on-board mission planning process and reducing system latency, providing solutions for efficient inter-satellite information transmission, autonomous operation and mission planning of the low-orbit mega-constellation.

Regarding the technical solution shown in FIG. 2, in some implementations, dividing satellites of the mega-constellation into satellite topology groups, so as to construct corresponding space-time grids based on a coverage on ground of each satellite topology group, includes:
dividing the satellites of the mega-constellation into the satellite topology groups based on inter-satellite connectivity and relative motion relationships, where adjacent satellite topology groups have inter-satellite links, and satellites in the same satellite topology group remain stationary relative to each other,
defining first-level grids each one of which matches a coverage capability of a single satellite topology group according to the coverage on ground of each satellite topology group,
setting second-level grids within each first-level grid based on the coverage on ground of a single satellite.

For the above implementation method, combined with the mega-constellation shown in FIG. 1, in some examples, topology division can be performed based on whether the communication between satellites is connected and whether the relative motion relationship is stable, and multiple satellite topology groups can be obtained. It should be noted that, the inter-satellite links can be realized between adjacent satellite topology groups by using the communication connections between satellite nodes at the edge of each satellite topology group, and all satellites within each satellite topology group can maintain a relatively stable operating relationship.

Based on this, for each satellite topology group, its radius rₜₒₚₒ can be constrained by the visibility of the satellite, that is

$${r}_{topo} < \frac{{l}_{A B}}{2} = \sqrt{{r}^{2} - ( {R}_{E} + H )} ,$$

where R_{E} is the radius of the earth, H is the thickness of the atmosphere, and l_{AB} is the distance between the center points of adjacent satellite topology groups A and B, r is the orbital radius of the satellite.

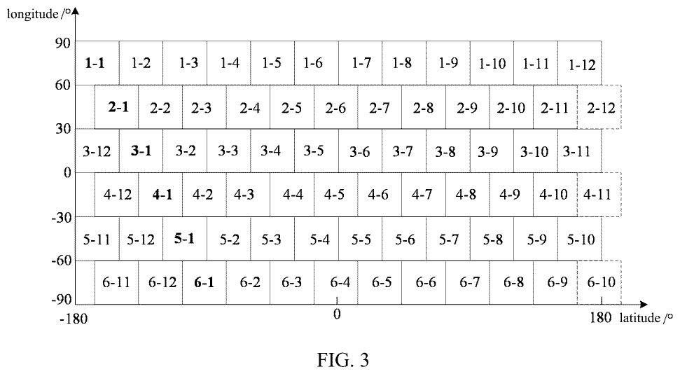

For the above implementation, in some examples, after obtaining the satellite topology groups, a first-level grid that can match the coverage capability of a single satellite topology group can be divided according to the coverage on ground of each satellite topology group, as shown in FIG. 3. For each first-level grid, the span of a single grid can be measured by the span of longitude and latitude in the equatorial region, that is:

$${l}_{{M}^{′} {N}^{′}} = 4 {R}_{E} arcsin ( {r}_{topo} / r )$$

$${lat}_{0} = {l}_{{M}^{′} {N}^{′}} / 111$$

$${lon}_{0} = {l}_{{M}^{′} {N}^{′}} / 111$$

Among them, l_{M′N′} is the boundary width of the satellite topology group projected on the ground, lat₀ is the latitude span of the first-level grid, and lon₀ is the longitude span of the first-level grid.

For the above implementation, in some examples, in each first-level grid, the scope of the second-level grid can be divided according to the constraints of the coverage on ground of a single satellite within the satellite topology group. It is worth noting that the second-level grid should be within the maximum coverage capacity of a single satellite, that is

$$a < \frac{\sqrt{2} H}{2 tan θ} ,$$

where a is the side length of the second-level grid, h is the satellite orbit height, and θ is the ground elevation angle corresponding to the satellite antenna. Understandably, the smallest second-level grid units can be arranged inside a first-level grid.

For the above implementation, in some examples, since all the satellites in the mega-constellation are not in the same orbital plane, but are scattered in orbital planes with different altitudes and orbital inclinations, in order to make the entire grid adaptable a variety of inclined orbit distributions, combined with the characteristics of orbital inclination angles, the grids in adjacent latitude bands can be set to be staggered, and the degree of staggering can be set to lat₀/2.

For the above implementation manner, in some examples, in order to be able to distinguish the first-level grids obtained by the above division, identifiers for identification or differentiation can be set accordingly. In the present disclosure, the longitude and latitude coordinates of the grid vertices can be used for encoding. Specifically, if the grid with the vertex latitude coordinates [lat₁, lat₁+lat₀, lat₁+lat₀, lat₁] and longitude coordinates [lon₁, lon₁, lon₁+lon₀, lon₁+lon₀] is encoded as A-B, as shown in FIG. 3, the positional relationship between this encoding and the grid is as follows:

$$A = [ \frac{180}{l a {t}_{0}} - \frac{l a {t}_{1} + 90}{l a {t}_{0}} + 1 ]$$

$$B = A + [ \frac{360}{l o {n}_{0}} - \frac{l o {n}_{1} + 180}{l o {n}_{0}} ] - 1$$

Among them, lat₁ is the latitude value of the lower left vertex of the first-level grid shown in FIG. 3, and lon₁ is the longitude value of the lower left vertex of the first-level grid shown in FIG. 3.

It is worth pointing out that based on the above implementation methods and examples, the sky-ground multi-scale space-time grid system of satellite resource location information can be solved.

For the technical solution shown in FIG. 2, in some implementations, obtaining a dynamic matching relationship in time domain between the space-time grids and the satellite topology groups based on a trajectory path of a sub-satellite point of satellites in each satellite topology group, includes:
accounting longitude spans generated by a sub-satellite point trajectory of a satellite in different latitude bands based on a latitude band distribution of the first-level grids,
representing the sub-satellite point trajectory of the satellite as its intersections with boundaries of the latitude bands, and representing a path of the satellite as discrete path endpoints for entering or exiting the different latitude bands based on the longitude spans generated by the sub-satellite point trajectory of the satellite in different latitude bands,
obtaining multi-period path endpoints, taking a periodic drift of an orbit of the satellite into account, by performing translation recursion during which an initial periodic path endpoint among the discrete path endpoints is used as a template,
matching the multi-period path endpoints with space-time grids to obtain a grid path spanned by the sub-satellite point trajectory of the satellite and the time to span a single grid,
obtaining a dynamic matching relationship in time domain between the space-time grids and the satellite topology groups according to the satellite topology group to which the satellite belongs and the grid path spanned by the sub-satellite point trajectory of the satellite and the time to span the single grid.

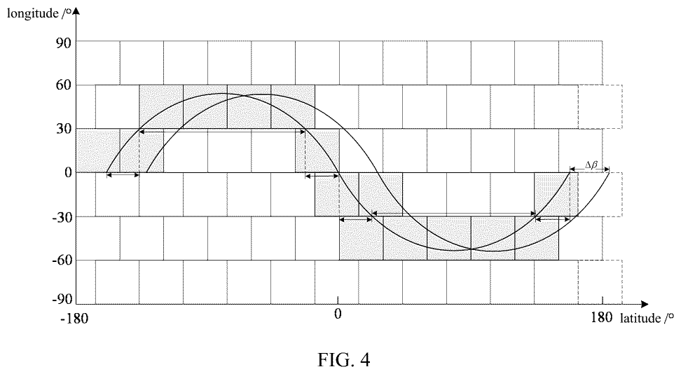

For the above implementation, as shown in FIG. 4, the latitude band can be divided by 7 latitude values lat_{c}, where {lat_{c}|lat_{c}=lat₀×k, −3≤k≤3}, k represents the latitude value serial number, therefore, the total number of latitude bands is 6. In some examples, after counting the longitude spans generated by the satellite's sub-satellite point trajectory in different latitude zones, the satellite's sub-satellite point trajectory can be represented by the intersection point with the boundary of the latitude zone. In some examples, the periodic drift of the satellite orbit due to the rotation of the earth is as follows:

Δβ=T_{N}(ωₑ−\dot{Ω}), where

$$\dot{Ω} = - \frac{3}{2} {J}_{2} {( \frac{{R}_{e}}{a ( 1 - {e}^{2} )} )}^{2} n cos i ,$$

T_{N} represents the node period of the satellite, ωₑ represents the earth's rotation angular velocity, \dot{Ω} represents the average angular velocity of the plane where the satellite orbit is drifting along the equator, J₂ is the main part of the earth's non-spherical perturbation, a, e, i are the long semi-axis, the eccentricity and orbital inclination of the satellite respectively, n is the angular velocity of the satellite. Combined with the above drift, using the starting cycle path endpoint of the satellite as a template, it can be deduced that the path point of the m-th cycle is a translation of span Δβ·m in the longitude direction, thus completing the translation recursion of the multi-cycle path endpoint, as shown in FIG. 4. In some examples, based on the multi-period path endpoints obtained by recursion, combined with the space-time grid obtained in the foregoing implementation, the first-level grid spanned by the satellite sub-satellite point trajectory can be matched, so that the path of the grid spanned by the satellite sub-satellite point trajectory and the duration of crossing a single grid can be obtained. Subsequently, according to the path of the grid spanned by the satellite sub-satellite point trajectory and the duration of crossing a single grid, the first-level grid path passed by the satellite topology group to which the satellite belongs (gray filling grid along the trajectory direction as shown in FIG. 4) and the specific duration across a single first-level grid can be obtained. It is worth pointing out that this implementation and example discretize the long-term motion of satellites in the constellation in space and time, so as to predict the topological resources that each grid can correspond to at different times, and then provide the dynamic matching relationship between the first-level grid and the satellite topological groups in the time domain, thus continuously providing satellites with neighborhood resource information.

For the technical solution shown in FIG. 2, in some implementations, setting a path weight for each space-time grid according to constellation deployment characteristic relationships and demand indicators, includes:
obtaining configuration parameters regarding orbital inclination and inter-satellite links in the mega-constellation,
assigning a path weight to each space-time grid with a set priority strategy based on the configuration parameters regarding orbital inclination and inter-satellite links.

Regarding the above implementation method, it should be noted that the orbital inclination of the mega-constellation can represent the orbital distribution of the mega-constellation, and the configuration of the inter-satellite link can represent the relative motion state between the satellites in the mega-constellation. The set priority strategies include priority in the same orbit, priority in non-polar regions, and priority in longitude spans less than 180°. Considering the above factors can ensure the stability of inter-satellite interconnection. Based on the above factors, each linked space-time grid is assigned a corresponding path weight.

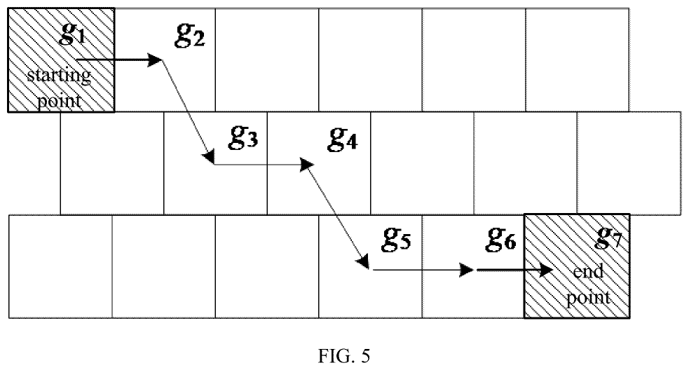

After obtaining the path weight, the grid set G {g₁, . . . gᵢ . . . gₙ} corresponding the shortest path can be obtained through the shortest path search algorithm based on the path weight, as shown in FIG. 5, taking 7 grids from the starting point to the end point as an example, this set can be considered as the static grid path initially planned for long-distance mission forwarding between satellites, when the mission is actually forwarded, local adjustments are made based on the preliminary planned static grid path, so as to obtain the actual grid path along which the mission is actually forwarded from the current satellite to the next satellite.

Based on this, for the technical solution shown in FIG. 2, in some implementations, adjusting the static grid path according to the satellite node currently receiving the mission and the dynamic matching relationship, so as to acquire the next satellite node to which the mission is forwarded from the satellite node currently receiving the mission, includes:
in the static grid path G={g₁, . . . gᵢ . . . gₙ}, performing the following steps for the i-th grid gᵢ where the satellite node that currently receives the mission is located:
obtaining satellite neighborhood resources of the i-th grid gi,
screening out a set of candidate satellite nodes from the satellite neighborhood resources according to the position of the satellite node currently receiving the mission and the dynamic matching relationship,
sorting the satellite nodes in the candidate satellite node set according to a availability thereof, and obtaining a satellite sⱼ with the best matching degree from the sorted candidate satellite set S={s₁, . . . sⱼ . . . sₘₐₓ} as a potential evaluation object,
determining whether the satellite sⱼ with the best matching degree can accept the mission, if yes, determining the satellite sⱼ with the best matching degree as the next satellite node to which the one satellite node currently receiving the mission forwards the mission, and obtaining the satellite neighborhood resources of the i+1th grid gᵢ₊₁ based on the next satellite node,
if no, using the satellite sⱼ₊₁ in the sorted candidate satellite set S={s₁, . . . sⱼ . . . sₘₐₓ} as a potential evaluation object to determine whether it can accept the mission,
until all satellites in the sorted candidate satellite set S={s₁, . . . sⱼ . . . sₘₐₓ} are unable to accept the mission, setting the path weight of the i-th grid gᵢ to 0, and obtaining a new static grid path G′ by searching which uses the i-th grid gᵢ₋₁ as the starting point, and adjusting the new static grid path G′ according to the satellite node currently receiving the mission and the dynamic matching relationship, so as to acquire the next satellite node to which the mission is forwarded from the satellite node currently receiving the mission.

Regarding the above implementation method, it should be noted that satellite neighborhood resources can be provided using the dynamic matching relationship between the first-level grid and the satellite topology group. Availability can include visual connectivity with the previous node satellite for mission information transmission and the matching degree of the grid position, so as to obtain the satellite with the best matching degree. In addition, whether the satellites in the candidate satellite set can accept mission information can be judged based on whether the satellite is currently in working state and the priority of the satellite's current mission. For example, if a satellite in the candidate satellite set is not currently in working state, it can be considered that the satellite can receive mission information. If the satellite is currently in working status, but the priority of the mission currently performed by the satellite is lower than the mission to be forwarded, then the satellite can also be considered to be able to accept the mission information.

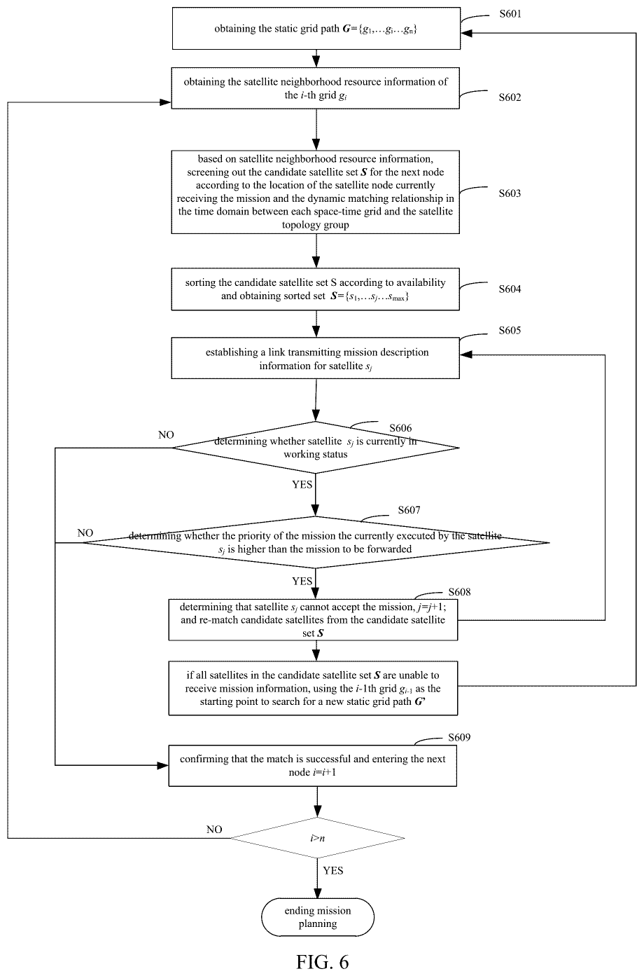

Based on this, the specific implementation process of the above implementation method is shown in FIG. 6 and includes:
S601: obtaining the static grid path G {g₁, . . . gᵢ . . . gₙ},
S602: obtaining the satellite neighborhood resource information of the i-th grid gᵢ,
S603: based on the satellite neighborhood resource information, screening out the candidate satellite set S for the next node according to the location of the satellite node currently receiving the mission and the dynamic matching relationship in the time domain between each space-time grid and the satellite topology group,
S604: sorting the candidate satellite set S according to availability and obtaining sorted set S={s₁, . . . sⱼ . . . sₘₐₓ},
S605: establishing a link transmitting mission description information for satellite si,
S606: determining whether satellite sⱼ is currently in working status:
if yes, go to S607,
if no, go to S609: confirming the matching is successful, and returning to S602 to obtain the satellite neighborhood resource information of the i+1th grid gᵢ,
S607: determining whether the priority of the mission the currently executed by the satellite sⱼ is higher than the mission to be forwarded:
if yes, execute S608: determining that satellite sⱼ cannot accept the mission, j=j+1, and re-match candidate satellites from the candidate satellite set S and return to execute S605, if all satellites in the candidate satellite set S are unable to accept the mission information, using the i−1th grid gᵢ₋₁ as the starting point to search for a new static grid path G′ and return to execution S601,
if no, go to S609: confirming the matching is successful, and return to S602 to obtain the satellite neighborhood resource information of the i+1th grid gᵢ₊₁, until all grids g; have completed the above process.

The above technical solutions provided by the present disclosure can be implemented in the form of hardware or in the form of software function modules. If it is implemented in the form of a software function module and is not sold or used as an independent product, it can be stored in a computer-readable storage medium. Based on this understanding, the part of the technical solution in the embodiment that makes substantial contributions to the prior art or the whole or part of the technical solution can be embodied in the form of a computer software product. This computer software product is stored in a non-transitory storage medium, including several instructions for making a computer device (which could be a personal computer, server, or network device, etc.) or a processor execute all or part of the steps of the method described in the embodiment. The aforementioned non-transitory storage medium includes USB flash drive, portable hard drive, read-only memory (ROM), random access memory (RAM), magnetic disk or optical disk, and various other mediums that can store program code.

Therefore, a non-transitory storage medium is provided according to an embodiment of the present disclosure, which has stored thereon computer-readable instructions that, when executed by a processor, cause the processor to perform the method for planning mission forwarding path for a mega-constellation in the aforementioned technical solution.

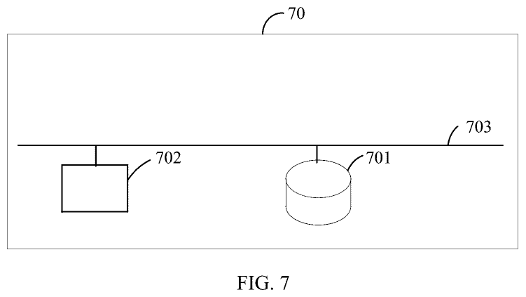

As shown in FIG. 7, as a specific hardware structure, an apparatus 70 for planning mission forwarding path for a mega-constellation is provided according to an embodiment of this disclosure. The apparatus 70 may include a memory 701 and a processor 702, the memory 701 and the processor 702 can be coupled together through a bus system 703. It could be understood that the bus system 703 is used for the connection communication between the memory 701 and the processor 702. The bus system 703 includes not only a data bus but also a power bus, a control bus, and a status signal bus. However, for the sake of clarity, all these kinds of buses are referred to as the bus system 703 in FIG. 7.

The memory 701 is configured for storing computer-readable instructions capable of running on the processor 702.

The processor 702 is configured for performing the following steps by running the computer-readable instructions:
dividing satellites of the mega-constellation into satellite topology groups, so as to construct corresponding space-time grids based on a coverage on ground of each satellite topology group,
obtaining a dynamic matching relationship in time domain between the space-time grids and the satellite topology groups based on a trajectory path of a sub-satellite point of satellites in each satellite topology group,
setting a path weight for each space-time grid according to constellation deployment characteristic relationships and demand indicators,
acquiring a static grid path for forwarding a mission by searching in the space-time grids based on a shortest path algorithm according to the path weight, where the static grid path is determined by an order of the space-time grids that need to be passed sequentially to forward the mission,
adjusting the static grid path according to the satellite node currently receiving the mission and the dynamic matching relationship, so as to acquire the next satellite node to which the mission is forwarded from the satellite node currently receiving the mission.

It could be understood that in the embodiment, the memory 701 can be either a volatile memory or a non-volatile memory, or include both a volatile memory and a non-volatile memory. Non-volatile memory can be Read-Only Memory (ROM), Programmable ROM (PROM), Erasable PROM (EPROM), Electrically EPROM (EEPROM), or flash memory. Volatile memory can be Random Access Memory (RAM), which is used as external high-speed cache. As illustrative examples, but not limited thereto, many forms of RAM can be used, such as static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), and direct rambus RAM (DRRAM). The memory 701 mentioned in the system and method described herein is intended to include but not limited to these and any other suitable types of memory.

The processor 702 can be an integrated circuit chip with signal processing capability. In the implementation, the various steps of the above method can be completed by an integrated logic circuit in the form of hardware in the processor 702 or instructions in the form of software. The processor 702 can be a general-purpose processor, digital signal processor (DSP), application-specific integrated circuit (ASIC), field-programmable gate array (FPGA), or other programmable logic devices, discrete gates, transistor logic devices, discrete hardware components, or any combination thereof. The general-purpose processor may be a microprocessor or the processor may also be any conventional processor, etc. The disclosed methods in the embodiment of the present disclosure can be executed directly by the hardware in a decoding processor, or can be executed by the combination of the hardware or software modules in a decoding processor. The software module can exist in common storage media such as random-access memory, flash memory, read-only memory, programmable read-only memory, electrically erasable programmable memory or registers. The non-transitory storage medium is in the memory 701, and the processor 702 reads the information from the memory 701 and executes the above method in conjunction with its hardware.

It could be understood that the embodiments described herein can be implemented using hardware, software, firmware, middleware, microcode, or a combination thereof. For the implementation in hardware, the processing unit can be implemented in one or more application specific integrated circuits (ASICs), digital signal processors (DSPs), DSP devices (DSPDs), programmable logic devices (PLDs), field-programmable gate arrays (FPGAs), general-purpose processors, controllers, microcontrollers, microprocessors, other electronic units for performing the functions disclosed herein, or a combination thereof.

For the implementation in software, the method described herein can be implemented using modules (e.g., procedures, functions, etc.) that perform the functions described herein. The software code can be stored in the memory and executed by the processor. The memory can be implemented inside or outside the processor.

It should be known that any combination of the technical solutions disclosed in the embodiments of the present disclosure can be made without conflict.

While the present disclosure has been described with reference to the exemplary embodiments, it should be understood that the present disclosure is not limited to the specific embodiments/examples described and illustrated in detail herein, and those skilled in the art can image any variation or substitution of the exemplary embodiments without departing from the protection scope defined by the claims.

What is claimed is:

1. A method for planning mission forwarding path for a mega-constellation, comprising:
dividing satellites of the mega-constellation into satellite topology groups, so as to construct corresponding space-time grids based on a coverage on ground of each satellite topology group;
obtaining a dynamic matching relationship in time domain between the space-time grids and the satellite topology groups based on a trajectory path of a sub-satellite point of satellites in each satellite topology group;
setting a path weight for each space-time grid according to constellation deployment characteristic relationships and demand indicators;
acquiring a static grid path for forwarding a mission by searching in the space-time grids based on a shortest path algorithm according to the path weight, wherein the static grid path is determined by an order of the space-time grids that need to be passed sequentially to forward the mission; and
adjusting the static grid path according to the satellite node currently receiving the mission and the dynamic matching relationship, so as to acquire the next satellite node to which the mission is forwarded from the satellite node currently receiving the mission.

2. The method according to claim 1, wherein dividing satellites of the mega-constellation into satellite topology groups, so as to construct corresponding space-time grids based on a coverage on ground of each satellite topology group, comprises:
dividing the satellites of the mega-constellation into the satellite topology groups based on inter-satellite connectivity and relative motion relationships, wherein adjacent satellite topology groups have inter-satellite links, and satellites in the same satellite topology group remain stationary relative to each other;
defining first-level grids each one of which matches a coverage capability of a single satellite topology group according to the coverage on ground of each satellite topology group; and
setting second-level grids within each first-level grid based on the coverage on ground of a single satellite.

3. The method according to claim 1, wherein obtaining a dynamic matching relationship in time domain between the space-time grids and the satellite topology groups based on a trajectory path of a sub-satellite point of satellites in each satellite topology group, comprises:
accounting longitude spans generated by a sub-satellite point trajectory of a satellite in different latitude bands based on a latitude band distribution of the first-level grids;
representing the sub-satellite point trajectory of the satellite as its intersections with boundaries of the latitude bands, and representing a path of the satellite as discrete path endpoints for entering or exiting the different latitude bands based on the longitude spans generated by the sub-satellite point trajectory of the satellite in different latitude bands;
obtaining multi-period path endpoints, taking a periodic drift of an orbit of the satellite into account, by performing translation recursion during which an initial periodic path endpoint among the discrete path endpoints is used as a template;
matching the multi-period path endpoints with space-time grids to obtain a grid path spanned by the sub-satellite point trajectory of the satellite and the time to span a single grid; and
obtaining a dynamic matching relationship in time domain between the space-time grids and the satellite topology groups according to the satellite topology group to which the satellite belongs and the grid path spanned by the sub-satellite point trajectory of the satellite and the time to span the single grid.

4. The method according to claim 1, wherein setting a path weight for each space-time grid according to constellation deployment characteristic relationships and demand indicators, comprises:
obtaining configuration parameters regarding orbital inclination and inter-satellite links in the mega-constellation; and
assigning a path weight to each space-time grid with a set priority strategy based on the configuration parameters regarding orbital inclination and inter-satellite links.

5. The method according to claim 1, wherein adjusting the static grid path according to the satellite node currently receiving the mission and the dynamic matching relationship, so as to acquire the next satellite node to which the mission is forwarded from the satellite node currently receiving the mission, comprises:
in the static grid path G={g₁, . . . gᵢ . . . gₙ}, performing the following steps for the i-th grid gᵢ where the satellite node that currently receives the mission is located:
obtaining satellite neighborhood resources of the i-th grid gi;
screening out a set of candidate satellite nodes from the satellite neighborhood resources according to the position of the satellite node currently receiving the mission and the dynamic matching relationship;
sorting the satellite nodes in the candidate satellite node set according to a availability thereof, and obtaining a satellite sⱼ with the best matching degree from the sorted candidate satellite set S={s₁, . . . sⱼ . . . sₘₐₓ} as a potential evaluation object;
determining whether the satellite sⱼ with the best matching degree can accept the mission, if yes, determining the satellite sⱼ with the best matching degree as the next satellite node to which the one satellite node currently receiving the mission forwards the mission, and obtaining the satellite neighborhood resources of the i+1th grid gᵢ₊₁ based on the next satellite node;
if no, using the satellite sⱼ₊₁ in the sorted candidate satellite set S={s₁, . . . sⱼ . . . sₘₐₓ} as a potential evaluation object to determine whether it can accept the mission; and
until all satellites in the sorted candidate satellite set S={s₁, . . . sⱼ . . . sₘₐₓ} are unable to accept the mission, setting the path weight of the i-th grid gᵢ to 0, and obtaining a new static grid path G′ by searching which uses the i-th grid gᵢ₋₁ as the starting point, and adjusting the new static grid path G′ according to the satellite node currently receiving the mission and the dynamic matching relationship, so as to acquire the next satellite node to which the mission is forwarded from the satellite node currently receiving the mission.

6. An apparatus for planning mission forwarding path for a mega-constellation, comprising a memory and a processor, wherein
the memory is configured for storing computer-readable instructions capable of running on the processor, and
the processor is configured for performing the following steps by running the computer-readable instructions:
dividing satellites of the mega-constellation into satellite topology groups, so as to construct corresponding space-time grids based on a coverage on ground of each satellite topology group;
obtaining a dynamic matching relationship in time domain between the space-time grids and the satellite topology groups based on a trajectory path of a sub-satellite point of satellites in each satellite topology group;
setting a path weight for each space-time grid according to constellation deployment characteristic relationships and demand indicators;
acquiring a static grid path for forwarding a mission by searching in the space-time grids based on a shortest path algorithm according to the path weight, wherein the static grid path is determined by an order of the space-time grids that need to be passed sequentially to forward the mission; and
adjusting the static grid path according to the satellite node currently receiving the mission and the dynamic matching relationship, so as to acquire the next satellite node to which the mission is forwarded from the satellite node currently receiving the mission.

7. The apparatus according to claim 6, wherein dividing satellites of the mega-constellation into satellite topology groups, so as to construct corresponding space-time grids based on a coverage on ground of each satellite topology group, comprises:
dividing the satellites of the mega-constellation into the satellite topology groups based on inter-satellite connectivity and relative motion relationships, wherein adjacent satellite topology groups have inter-satellite links, and satellites in the same satellite topology group remain stationary relative to each other;
defining first-level grids each one of which matches a coverage capability of a single satellite topology group according to the coverage on ground of each satellite topology group; and
setting second-level grids within each first-level grid based on the coverage on ground of a single satellite.

8. The apparatus according to claim 6, wherein obtaining a dynamic matching relationship in time domain between the space-time grids and the satellite topology groups based on a trajectory path of a sub-satellite point of satellites in each satellite topology group, comprises:
accounting longitude spans generated by a sub-satellite point trajectory of a satellite in different latitude bands based on a latitude band distribution of the first-level grids;
representing the sub-satellite point trajectory of the satellite as its intersections with boundaries of the latitude bands, and representing a path of the satellite as discrete path endpoints for entering or exiting the different latitude bands based on the longitude spans generated by the sub-satellite point trajectory of the satellite in different latitude bands;
obtaining multi-period path endpoints, taking a periodic drift of an orbit of the satellite into account, by performing translation recursion during which an initial periodic path endpoint among the discrete path endpoints is used as a template;
matching the multi-period path endpoints with space-time grids to obtain a grid path spanned by the sub-satellite point trajectory of the satellite and the time to span a single grid; and
obtaining a dynamic matching relationship in time domain between the space-time grids and the satellite topology groups according to the satellite topology group to which the satellite belongs and the grid path spanned by the sub-satellite point trajectory of the satellite and the time to span the single grid.

9. The apparatus according to claim 6, wherein setting a path weight for each space-time grid according to constellation deployment characteristic relationships and demand indicators, comprises:
obtaining configuration parameters regarding orbital inclination and inter-satellite links in the mega-constellation; and
assigning a path weight to each space-time grid with a set priority strategy based on the configuration parameters regarding orbital inclination and inter-satellite links.

10. The apparatus according to claim 6, wherein adjusting the static grid path according to the satellite node currently receiving the mission and the dynamic matching relationship, so as to acquire the next satellite node to which the mission is forwarded from the satellite node currently receiving the mission, comprises:
in the static grid path G={g₁, . . . gᵢ . . . gₙ}, performing the following steps for the i-th grid gᵢ where the satellite node that currently receives the mission is located:
obtaining satellite neighborhood resources of the i-th grid gi;
screening out a set of candidate satellite nodes from the satellite neighborhood resources according to the position of the satellite node currently receiving the mission and the dynamic matching relationship;
sorting the satellite nodes in the candidate satellite node set according to a availability thereof, and obtaining a satellite sⱼ with the best matching degree from the sorted candidate satellite set S={s₁, . . . sⱼ . . . sₘₐₓ} as a potential evaluation object;
determining whether the satellite sⱼ with the best matching degree can accept the mission, if yes, determining the satellite sⱼ with the best matching degree as the next satellite node to which the one satellite node currently receiving the mission forwards the mission, and obtaining the satellite neighborhood resources of the i+1th grid gᵢ₊₁ based on the next satellite node;
if no, using the satellite sⱼ₊₁ in the sorted candidate satellite set S={s₁, . . . sⱼ . . . sₘₐₓ} as a potential evaluation object to determine whether it can accept the mission; and
until all satellites in the sorted candidate satellite set S={s₁, . . . sⱼ . . . sₘₐₓ} are unable to accept the mission, setting the path weight of the i-th grid gᵢ to 0, and obtaining a new static grid path G′ by searching which uses the i-th grid gᵢ₋₁ as the starting point, and adjusting the new static grid path G′ according to the satellite node currently receiving the mission and the dynamic matching relationship, so as to acquire the next satellite node to which the mission is forwarded from the satellite node currently receiving the mission.

11. A non-transitory storage medium having stored thereon computer-readable instructions that, when executed by a processor, cause the processor to perform a method for planning mission forwarding path for a mega-constellation, the method comprising:
dividing satellites of the mega-constellation into satellite topology groups, so as to construct corresponding space-time grids based on a coverage on ground of each satellite topology group;
obtaining a dynamic matching relationship in time domain between the space-time grids and the satellite topology groups based on a trajectory path of a sub-satellite point of satellites in each satellite topology group;
setting a path weight for each space-time grid according to constellation deployment characteristic relationships and demand indicators;
acquiring a static grid path for forwarding a mission by searching in the space-time grids based on a shortest path algorithm according to the path weight, wherein the static grid path is determined by an order of the space-time grids that need to be passed sequentially to forward the mission; and
adjusting the static grid path according to the satellite node currently receiving the mission and the dynamic matching relationship, so as to acquire the next satellite node to which the mission is forwarded from the satellite node currently receiving the mission.

12. The non-transitory storage medium according to claim 11, wherein dividing satellites of the mega-constellation into satellite topology groups, so as to construct corresponding space-time grids based on a coverage on ground of each satellite topology group, comprises:
dividing the satellites of the mega-constellation into the satellite topology groups based on inter-satellite connectivity and relative motion relationships, wherein adjacent satellite topology groups have inter-satellite links, and satellites in the same satellite topology group remain stationary relative to each other;
defining first-level grids each one of which matches a coverage capability of a single satellite topology group according to the coverage on ground of each satellite topology group; and
setting second-level grids within each first-level grid based on the coverage on ground of a single satellite.

13. The non-transitory storage medium according to claim 11, wherein obtaining a dynamic matching relationship in time domain between the space-time grids and the satellite topology groups based on a trajectory path of a sub-satellite point of satellites in each satellite topology group, comprises:
accounting longitude spans generated by a sub-satellite point trajectory of a satellite in different latitude bands based on a latitude band distribution of the first-level grids;
representing the sub-satellite point trajectory of the satellite as its intersections with boundaries of the latitude bands, and representing a path of the satellite as discrete path endpoints for entering or exiting the different latitude bands based on the longitude spans generated by the sub-satellite point trajectory of the satellite in different latitude bands;
obtaining multi-period path endpoints, taking a periodic drift of an orbit of the satellite into account, by performing translation recursion during which an initial periodic path endpoint among the discrete path endpoints is used as a template;
matching the multi-period path endpoints with space-time grids to obtain a grid path spanned by the sub-satellite point trajectory of the satellite and the time to span a single grid; and
obtaining a dynamic matching relationship in time domain between the space-time grids and the satellite topology groups according to the satellite topology group to which the satellite belongs and the grid path spanned by the sub-satellite point trajectory of the satellite and the time to span the single grid.

14. The non-transitory storage medium according to claim 11, wherein setting a path weight for each space-time grid according to constellation deployment characteristic relationships and demand indicators, comprises:
obtaining configuration parameters regarding orbital inclination and inter-satellite links in the mega-constellation; and
assigning a path weight to each space-time grid with a set priority strategy based on the configuration parameters regarding orbital inclination and inter-satellite links.

15. The non-transitory storage medium according to claim 11, wherein adjusting the static grid path according to the satellite node currently receiving the mission and the dynamic matching relationship, so as to acquire the next satellite node to which the mission is forwarded from the satellite node currently receiving the mission, comprises:
in the static grid path G={g₁, . . . gᵢ . . . gₙ}, performing the following steps for the i-th grid gᵢ where the satellite node that currently receives the mission is located:
obtaining satellite neighborhood resources of the i-th grid gi;
screening out a set of candidate satellite nodes from the satellite neighborhood resources according to the position of the satellite node currently receiving the mission and the dynamic matching relationship;
sorting the satellite nodes in the candidate satellite node set according to a availability thereof, and obtaining a satellite sⱼ with the best matching degree from the sorted candidate satellite set S={s₁, . . . sⱼ . . . sₘₐₓ} as a potential evaluation object;
determining whether the satellite sⱼ with the best matching degree can accept the mission, if yes, determining the satellite sⱼ with the best matching degree as the next satellite node to which the one satellite node currently receiving the mission forwards the mission, and obtaining the satellite neighborhood resources of the i+1th grid gᵢ₊₁ based on the next satellite node;
if no, using the satellite sⱼ₊₁ in the sorted candidate satellite set S={s₁, . . . sⱼ . . . sₘₐₓ} as a potential evaluation object to determine whether it can accept the mission; and
until all satellites in the sorted candidate satellite set S={s₁, . . . sⱼ . . . sₘₐₓ} are unable to accept the mission, setting the path weight of the i-th grid gᵢ to 0, and obtaining a new static grid path G′ by searching which uses the i-th grid gᵢ₋₁ as the starting point, and adjusting the new static grid path G′ according to the satellite node currently receiving the mission and the dynamic matching relationship, so as to acquire the next satellite node to which the mission is forwarded from the satellite node currently receiving the mission.
